(19) United States
(12) Patent Application Publication
(10) Pub. No.: US 2019/0035144 A1
(43) Pub. Date: Jan. 31, 2019

(54) METHOD FOR CREATING A 3D MODEL OF AN OBJECT

(71) Applicant: Testo SE & Co. KGaA, Lenzkirch (DE)

(72) Inventors: Jan-Friso Evers-Senne, Titisee-Neustadt (DE); Patrick Zahn, Titisee-Neustadt (DE)

(73) Assignee: Testo SE & Co. KGaA, Lenzkirch (DE)

(21) Appl. No.: 16/042,188

(22) Filed: Jul. 23, 2018

(30) Foreign Application Priority Data
Jul. 27, 2017 (DE) 102017117049.9

(51) Int. Cl. G06T 17/05; B64C 39/02; G06T 3/00

(52) U.S. Cl. CPC G06T 17/05; B64C 39/024; G06T 3/0018; B64C 2201/108; B64C 2201/127; B64C 2201/141; B64C 2201/123

(57) ABSTRACT

A method for creating a 3D model of an object (1), in which a rotary wing drone (2) with at least one image recording apparatus (3) is used to record a plurality of at least partly overlapping images of the object (1) and the 3D model is calculated therefrom. The rotary wing drone (2) continuously measures the distance from the object (1) with at least one distance sensor (4) and independently flies over the object (1) at a predetermined distance (7) and the flyover is terminated once the object (1) has been recorded in its entirety.

### INCORPORATION BY REFERENCE

The following documents are incorporated herein by reference as if fully set forth: German Patent Application No. 10 2017 117 049.9, filed Jul. 27, 2017.

### BACKGROUND

The invention describes a method for creating a 3D model of an object, in which a plurality of images of the object are recorded from different recording poses and the 3D model is calculated therefrom.

A plurality of methods are known for calculating 3D models from individual images. What is important here is that the images overlap so far that individual elements or features can be identified and assigned in a plurality of images.

It was found that a difficulty often arising when calculating 3D models of relatively large objects is that of creating images at heights that are difficult to access. Intending to model a façade of a skyscraper would be one example.

To this end, the use of so-called rotary wing drones that are equipped with at least one camera is known. Additional difficulties arising here are that available rotary wing drones are not usable, as a rule, at difficult to access points since, firstly, the user must produce special qualifications and, secondly, the use of rotary wing drones is subject to strict conditions, precisely in populated areas.

By way of example, it is known that a defined distance has to be maintained from, for instance, streets or other transportation routes, making difficult, or even preventing, the examination of many buildings situated in the vicinity of these transportation routes.

### SUMMARY

It is an object of the invention to develop a method and an apparatus for creating a 3D model of an object, which also permit the surveying of large objects in a simple and safe manner.

This object is achieved by a method and an apparatus having one or more features of the invention.

In particular, the method according to the invention is consequently characterized in that a rotary wing drone using at least one image recording apparatus independently captures the object and independently flies over the object—preferably at a predetermined distance—and records at least partly overlapping images of the object. Here, the rotary wing drone can be embodied as a measuring appliance or it can be part of a measuring appliance which, additionally, still comprises a stationary unit.

As a result of the rotary wing drone flying over the object at a predetermined distance, the use in difficult to access positions and at great heights is also possible. Then, the image recording apparatus is preferably configured in such a way that it records images that at least partly overlap. This ensures that image features are identifiable in a plurality of images for assignment purposes.

It is particularly advantageous if the rotary wing drone continuously determines the distance from the object and/or the profile of the object and independently maintains the predetermined distance. Here, the rotary wing drone can monitor and maintain a predetermined minimum distance and/or a predetermined maximum distance. Particularly advantageously, it is possible to modify the distance depending on the flight level and/or the flight speed.

This is advantageous in that the rotary wing drone maintains the distance practically in autonomous fashion, and so it is also usable in very unclear situations or at great heights. This could also lead to exceptional permissions being granted for the operation of the rotary wing drone in regions that are in fact closed off.

In this case, or in general, provision can be made for the rotary wing drone to independently identify the object to be captured and the object boundaries. By way of example, if a building façade were to be captured, the object boundary could be the corner of the building at which the façade ends in this alignment.

Here, it initially flies over the object at the predetermined distance in one direction, until it identifies an object boundary. There, it can change the height and the direction until it once again arrives at an object boundary.

In an advantageous embodiment of the invention, the rotary wing drone is configured in such a way that it flies over the object along a previously set object contour or a previously set path. To this end, a flight route can be set as a path, for example on the basis of a blueprint or the like. This can be stored in the rotary wing drone or in a control apparatus. After take-off, the rotary wing drone then flies over this path along the object, wherein, as described above, it independently maintains the distance from the object. Therefore, it is only necessary to set the path in two dimensions in the plane to be captured.

In a preferred embodiment of the invention, the rotary wing drone is configured in such a way that the flyover is terminated once the object has been recorded in its entirety. Consequently, a fully automatic performance of data capture for calculating a 3D model of the object is achievable.

It is particularly advantageous if the rotary wing drone flies over the object in a horizontal and/or vertical direction in a row-like or column-like manner. As a result, the object is captured completely in a simple manner. Moreover, a sufficient coverage of the images can be easily obtained thereby.

By way of example, the capture ends when the entire object has been captured. Here, the capture is carried out fully automatically and autonomously, and so, in principle, no user interaction is necessary.

In particular, the rotary wing drone can take off from any take-off point in this method. Then, it can find its use location independently, for example by GPS or other locating methods.

It is particularly advantageous if the object is captured by distance sensors. A simple measurement of the distance can be implemented by the distance sensor, which may be a known laser or ultrasonic distance sensor, for example, and so the rotary wing drone can maintain the distance very accurately.

As an alternative or in addition to a dedicated distance sensor, distance information also can be obtained from the recorded image data, for example by way of a structure-from-motion method.

Independently of the employed method of determining the distance, it is thereby possible to quickly react to changes in the distance, for instance in the case of obstacles protruding from the object. This can be used to increase the distance to an object if such an obstacle, for example a balcony or the like, is detected.

It may be advantageous if the rotary wing drone is operated with an oblique main viewing direction onto the object in order to look ahead at the path of its route. Here, a distance sensor can be arranged with a slight inclination in the flight direction. Since there is a change in the flight direction, it is particularly advantageous if at least two distance sensors are present, which each look ahead in one flight direction. The image recording apparatus, in particular the camera, too, can be inclined in this direction. Alternatively, the camera and/or the distance sensor may also have a movable arrangement, and so these can be aligned in the flight direction in each case.

As a result, the identification of obstacles protruding into the flight path, in particular, is improved.

As a result of inexpedient ambient conditions or object properties, for example as a result of reflections, it may be the case that the sensor system cannot obtain sufficient information. In this case, it may be advantageous if the rotary wing drone supports the capture of the object by flight movements that deviate from the flight path. In this case, the rotary wing drone can carry out roll, pitch or yaw movements in order thus to simplify or facilitate the capture by the sensors.

The rotary wing drone can have laterally oriented distance sensors for improved capture of the object boundaries and for identifying obstacles in the flight path. As a result, it is also possible to avoid a collision in the case of a horizontal movement transversely to the main viewing direction.

In an advantageous configuration, provision can be made for the rotary wing drone to be configured to capture at least one geometric primitive that is predetermined by a building wall. By way of example, this can be carried out by fitting into a cloud of measurement points. Here, the measurement points could have been recorded, for example, using a stereoscopic distance sensor or a scanner or, in general, a 2D distance sensor, with which the rotary wing drone may be equipped and/or with which spatially dependent and/or viewing-angle-dependent distance information is obtainable. Consequently, an approximated image of the object or of the contour thereof is obtainable and providable for a flight controller of the rotary wing drone.

Preferably, the at least one primitive is a plane or cylinder wall. Consequently, many buildings can be approximated by a fitting number and type of geometric primitives.

Here, provision can be made for the rotary wing drone to be configured to calculate a flight trajectory, for example the aforementioned flight trajectory, of the rotary wing drone in relation to the at least one geometric primitive. Consequently, an independent flyover of the surface of the building wall is performable, without distance sensors having to be active continuously.

The moment of ascending is also problematic as the rotary wing drone could strike an obstacle from below. Here, the rotors make a direct distance measurement more difficult, particularly when the rotary wing drone has compact dimensions.

Therefore, it is advantageous for an automatic capture of an object if the rotary wing drone also has an upward distance sensor. This can be achievable, for example, by an appropriate arrangement of the rotors in such a way that space is left between the rotors or else by an arrangement of a sensor above the plane in which the rotors rotate.

In an advantageous embodiment of the invention, there is a warning for the user should the rotary wing drone drop below a set minimum distance from the object and/or should the rotary wing drone exceed a set maximum distance from the object. Since the rotary wing drone independently maintains its distance from the object according to the invention, dropping below or exceeding this distance may indicate a serious fault. The user receives notification by way of the warning, and so the use of the rotary wing drone overall becomes safer. An error tolerance of the predetermined distance can be taken into account in the warning, and so a certain deviation is permitted.

In an advantageous development of the invention, the images are recorded in an image recording apparatus arranged at the rotary wing drone. By way of example, this image recording apparatus can be a digital camera. The recorded images can be stored within the rotary wing drone in an image memory or they can be sent to a monitoring or base unit still during the capture.

In a particularly expedient embodiment of the invention, an image or video stream of the image recording apparatus is transmitted to a receiver for the purposes of monitoring the work of the rotary wing drone. A video data stream, in particular, can be compressed in order to reduce the amount of data. Such a live image allows a user to monitor the capture, even when the rotary wing drone flies outside of the field of vision of the user.

In a particularly advantageous embodiment of the invention, the recording apparatus has a fisheye camera. This is advantageous in that one image already captures a large image angle. On the one hand, this can be used to create a model with as few images as possible. However, it can also lead to the necessary distance from the object being able to be selected to be smaller. As a result, the safety during the flight operation of the rotary wing drone can be increased since the flight need not be carried out at such a great distance into the free air space in front of a building. On the other hand, meaningful image recordings still can be produced in very narrow streets or in the case of there being little space in front of the building.

As a rule, the 3D model can be correctly scaled on the basis of the recorded image data and a possibly present distance measurement.

However, it may be advantageous if, initially, a mark for assisting the distance measurement and scaling of the object is arranged at the object. Based on the known dimensions of the mark, for example a mark panel with known structures, the image or the images on which the mark is visible can be used to determine the scale.

It is particularly helpful if the distance information or scale information is transferred from an image with marks to other images without marks.

Here, it can be helpful if robust and precise image features are identified in the recorded images, said image features allowing a simple registration of the individual images in relation to one another.

Here, the images can be recorded at predetermined and/or regular spacings or intervals.

The frame rate or image recording rate is varied in an advantageous embodiment of the invention. This can be determined depending on the image angle, the distance to the object, the flight speed and/or further parameters.

In particular, it is advantageous if the image recording rate is varied depending on the creation of the 3D model, for example in order to improve a desired accuracy or coverage at a desired point.

To this end, it is advantageous if the calculation of the 3D model is effected in a timely fashion such that, where necessary, further images can be recorded at certain points. In one embodiment of the invention, the rotary wing drone, to this end, can fly over an object with a predetermined coarse recording grid. Thereupon, a 3D model can be created on account of these image data. Finally, further images can be recorded in a second flight in those regions in which the accuracy of the model is not sufficient.

However, it is particularly advantageous if the 3D model is calculated in real time. As a result, it is immediately possible to recognize whether further images in a tighter grid are required at a position of the object. The calculation of the 3D model can be accelerated, in particular, by reducing the images to corners and vertices. As a result, the calculation can be carried out using, for example, less powerful hardware in the rotary wing drone itself such that the transmission of the image data to a stationary calculation unit is not necessary.

The invention also includes a measuring appliance for surveying an object, having at least one rotary wing drone, on which at least one image recording apparatus is arranged for recording images of the object, characterized in that the rotary wing drone has at least one apparatus for determining the distance to an object and a controller including a processor that is embodied to carry out a method according to the invention.

It is particularly expedient if the image recording apparatus has a fisheye optical unit.

It is also advantageous if the rotary wing drone has an upward distance sensor. This also allows the recognition of obstacles above the rotary wing drone, and so possible collisions can be avoided during the ascent in the vertical direction.

In particular, this can be achieved by virtue of the rotors being arranged in such a way that there is a viewing window for the distance sensor between the rotors or the sensor is arranged above the rotor plane.

### BRIEF DESCRIPTION OF THE DRAWINGS

Below, the invention is explained in more detail on the basis of an exemplary embodiment, with reference being made to the attached drawings.

In the figures:

FIG. 1 shows a schematic view of a measuring appliance according to the invention with a quadcopter at different times of a measuring process, and

FIG. 2 shows a schematic illustration of a flight route of a rotary wing drone along an object.

### DETAILED DESCRIPTION

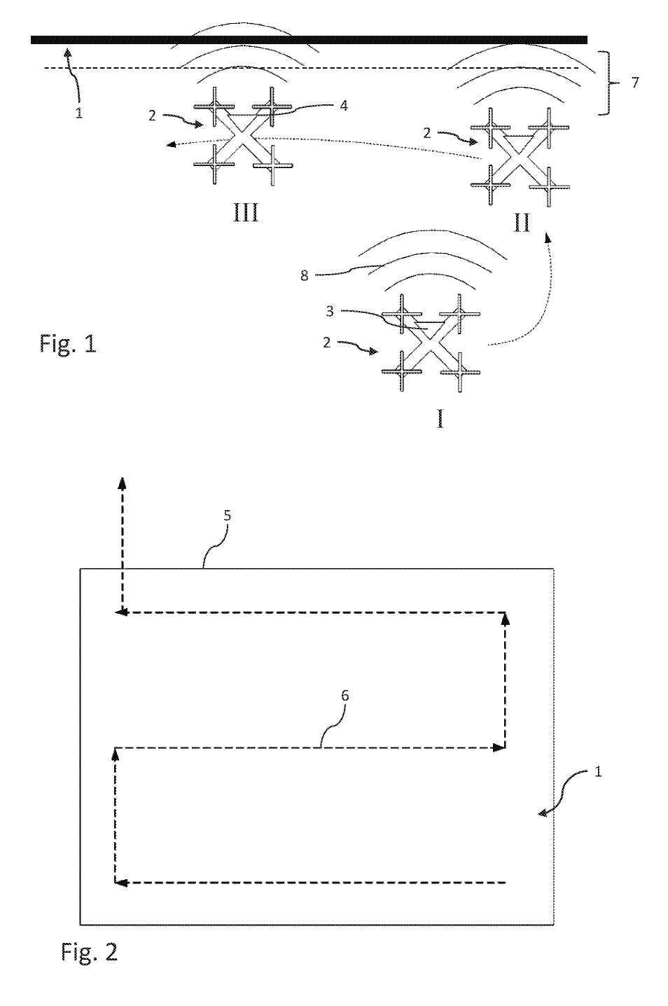

FIG. 1 schematically shows an object to be measured, for example a façade 1 of a building, in a plan view. In the image, the façade 1 stands perpendicular out of the plane of the drawing.

In the example, a measuring appliance 2 according to the invention has a quadcopter. However, use can also be made of any other aircraft or rotary wing drone, for example an octocopter or hexacopter.

The quadcopter 2 further has an image recording apparatus 3, which is embodied as a digital camera, for example. In particular, the camera 3 has a fisheye lens in order to capture an image angle that is as large as possible.

Moreover, the quadcopter 2 has at least one distance sensor 4, which is aligned perpendicular to the propeller plane and which determines the distance of the quadcopter 2 from the façade 1.

In FIG. 1, the quadcopter is initially shown in a take-off position I, in which the distance sensor 4 is aligned in such a way that it faces the façade 1. In the figure, it is perpendicular to the façade 1, although this is not a precondition. What is important is that the distance sensor 4 can capture the façade 1.

Now, a first embodiment of the method according to the invention provides for the outlines or the contour 5 of the object, the façade 1 in this example, and a flight route 6 to be set in advance. Then, after taking off start from its take-off position I, the quadcopter 2 will fly perpendicular toward the façade 1 until the predetermined distance in a measuring position II has been reached.

Then the quadcopter flies over the façade along the set flight route, with position III representing a section in time. Here, the distance from the façade 1 is measured and corrected where necessary, either continuously or at intervals. The flyover of the façade 1 is terminated once the entire façade 1 has been captured.

A second alternative embodiment of the invention provides for the rotary wing drone 2, after taking off from the take-off position I, to initially fly toward the façade 1 to the predetermined distance and then to fly along the façade 1 in one direction until the distance sensor 4 or further sensors identify an end of the façade 1. Then, the rotary wing drone 2 changes its height and flies in the opposite direction until the end of the façade 1 has been reached in this case, too. A corresponding flight route 6 is shown in FIG. 2 in an exemplary manner. In this case, the flight route 6 shown in FIG. 2 also could have been set in advance, as described above.

However, the advantage of the second embodiment is that the rotary wing drone 2 can capture an object practically autonomously and independently. In the process, it is also possible to observe possibly prevalent minimum or maximum distances.

In a further exemplary embodiment, the rotary wing drone 2 also can be configured to measure a number of distance measurement points from the façade. Consequently, the rotary wing drone can obtain a point cloud in which it subsequently independently fits a geometric primitive, for example a section of a plane or of a cylinder lateral face, or a plurality of different primitives of said type. The rotary wing drone 2 now can calculate a flight path 6, which extends to a defined distance from a surface that was approximately described by the geometric primitives.

### LIST OF REFERENCE SIGNS

1 Object, façade
2 Measuring appliance, rotary wing drone, in particular quadcopter
3 Image recording apparatus, camera
4 Distance sensor
5 Contour
6 Flight route, flight path, path
7 Distance
8 Main viewing direction

1. A method for creating a 3D model of an object (1), comprising:
recording a plurality of images of the object (1) from different recording poses;
calculating the 3D model from the plurality of captured images;
capturing the plurality of images using a rotary wing drone (2) including at least one image recording apparatus (3) that independently captures the object (1) and independently flies over the object (1) and records at least partly overlapping images of the object (1) at a distance (7).

2. The method as claimed in claim 1, further comprising the rotary wing drone (2) continuously determining the distance (7) from at least one of the object (1) or a profile of the object (1), and the rotary wing drone (2) independently maintaining the predetermined distance (7).

3. The method as claimed in claim 1, wherein the rotary wing drone (2) flies over the object (1) along at least one of a previously set object contour (5) or a previously set path (6).

4. The method as claimed in claim 1, further comprising terminating the flyover once an entirety of the object (1) has been recorded.

5. The method as claimed in claim 1, further comprising at least one of determining the distance of the rotary wing drone (2) from the object (1) by distance sensors (4) or evaluating recorded images using a structure-from-motion method.

6. The method as claimed in claim 1, wherein the rotary wing drone (2) supports the capturing of the images of the object (1) by flight movements that deviate from the flight path.

7. The method as claimed in claim 1, wherein the rotary wing drone (2) flies over the object (1) in at least one of a horizontal or vertical direction in a row-like or column-like manner.

8. The method as claimed in claim 1, wherein the rotary wing drone (2) is operated with an oblique main viewing direction (8) onto the object (1) in order to look ahead at the path of a flight route (6) to identify obstacles that project into the flight path.

9. The method as claimed in claim 1, wherein the rotary wing drone (2) includes laterally oriented distance sensors in order to avoid a collision for a horizontal movement transversely to a main viewing direction (8).

10. The method as claimed in claim 1, wherein at least one of: (a) the rotary wing drone is configured to capture at least one geometric primitive that is predetermined by a building wall or (b) the rotary wing drone is configured to calculate a flight trajectory in relation to the at least one geometric primitive.

11. The method as claimed in claim 1, further comprising at least one of: (a) recording the images in an image recording apparatus (3) arranged at the rotary wing drone (2) or (b) transmitting a video stream of the image recording apparatus (3) to a receiver for the purposes of monitoring the work of the rotary wing drone.

12. The method as claimed in claim 1, further comprising the rotary wing drone (2) warning the user should the rotary wing drone (2) drop below a set minimum distance from the object (1) or should the rotary wing drone exceed a set maximum distance from the object (1), or both.

13. The method as claimed in claim 1, wherein, initially, a mark for assisting a distance measurement and scaling of the object (1) is arranged at the object (1) and the method further comprising transferring distance information or scale information from an image with the mark to other images without marks.

14. The method as claimed in claim 1, wherein a frame rate or image recording rate is varied to improve a desired accuracy or coverage at a desired point.

15. The method as claimed in claim 1, further comprising calculating the 3D model is calculated in real time, and reducing the images to corners and vertices for accelerating the calculation.

16. A measuring appliance for surveying an object, comprising:
a rotary wing drone (2),
at least one image recording apparatus (3) arranged on the rotary wing drone (2) for recording images of the object (1),
the rotary wing drone has at least one apparatus for determining a distance (7) to an object (1) and a controller configured to carry out the steps of recording a plurality of images of the object (1) from different recording poses, calculating the 3D model from the plurality of captured images, and capturing the plurality of images using the at least one image recording apparatus (3) by the rotary wing drone (2) independently flying over the object (1) and recording at least partly overlapping images of the object (1) at a distance (7).

17. The measuring appliance as claimed in claim 16, wherein the image recording apparatus has fisheye optics.

18. The measuring appliance as claimed in claim 16, wherein the rotary wing drone (2) includes a distance sensor, and rotors of the rotary wing drone are arranged in such a way that there is a viewing window for the distance sensor between the rotors or the distance sensor is arranged above the rotor plane.
